(19) United States
(12) Patent Application Publication
(10) Pub. No.: US 2009/0011352 A1
(43) Pub. Date: Jan. 8, 2009

(54) Process for preparing novel composite imaging materials and novel composite imaging materials prepared by the process

(76) Inventor: John Francis Cooper, Black Mountain, NC (US)

Correspondence Address: John F. Cooper, PO Box 26, Black Mountain, NC, 28711, US

(21) Appl. No.: 12/009,124

(22) Filed: Jan. 17, 2008

Related U.S. Application Data
(60) Provisional application No. 60/937,967, filed on Jul. 2, 2007.

(51) Int. Cl. G03G 9/087; G03G 9/097; G03G 9/18

(52) U.S. Cl. 430/108.1; 430/137.14; 430/137.22; 430/112; 430/105

(57) ABSTRACT

The invention relates to a versatile process for preparing composite powders that can be used as novel electrostatic charge control agents, dry or liquid toners, and specialty imaging materials. The process involves impregnating specific sized, porous, inorganic core particles with chemical compositions that include one or more polymers or waxes and at least one additional chemical chosen from dyes, pigments, carbon black, inorganic chemicals or organic chemicals. The impregnated core may optionally be coated with additional components to produce a core/shell structure.

### FIELD OF THE INVENTION

The instant invention relates to a versatile process for preparing composite powders that can be used as novel electrostatic charge control agents, dry or liquid toners, and specialty imaging materials. The inventive process involves impregnating specific sized, porous, inorganic core particles with at least one wax or polymer and one or more additional components selected from dyes, pigments, colorants, inorganic chemicals or organic chemicals. The impregnated core may optionally be coated with additional components to produce a core/shell structure.

### BACKGROUND

A variety of imaging applications require powders with specific particle size distributions, electrostatic charge and frequently complex compositions. A few examples include dry or liquid electrophotographic toners, electrostatic charge control agents used for dry or liquid toners or powder coatings, and fluorescent or phosphorescent marking particles used for security or identification purposes. Current processes used to produce these particles are typically complex, expensive, and may not be versatile enough to produce a wide variety of such powders.

The use of dry toners to print electrostatic or magnetographic images has been practiced for over 50 years. Such toners have evolved from relatively simple compositions of polymer and carbon black pigment to today's toners which typically comprise one or more polymers, pigments, waxes, charge control agents and a wide variety of particulate additives. Imaging of such toners is most commonly accomplished by an electrophotographic process that involves charging of a photoreceptor, selective discharge of the photoreceptor via light lens, laser or LED, imagewise deposition of toner particles onto the photoreceptor, transfer of the toner particles to paper or other substrate and fusing of the deposited toner. Typically the photoreceptor is cleaned for reuse.

Current electrophotographic printing systems are placing increasing demands on toners, both in terms of image quality and also machine reliability. The toners must provide sharp, dense, low background, and well-fixed images. Color images must have appropriate hue, saturation and a certain level of gloss. The toners must be compatible with printer sub systems to contribute to photoreceptor cleaning and fuser release. To achieve these goals toners are designed with smaller and narrow particle size distributions, stable charge distributions, and specific melt rheology. These toner properties are obtained by specific compositions of polymers, pigments, colorants, charge control agents, waxes and miscellaneous additives.

To meet the challenges of current toner-based hardware has become a challenge for current toner designers. In particular, there are issues related to using significant quantities of wax in toners, uniform toner charging, ability to use novel polymers, and control of particular shape and size. Each of these issues is addressed by the current invention. In addition, the current invention allows for the production of unique toners and additives that can be incorporated into toners and powders to improve their performance.

A first objective of the inventive process was a versatile process for preparing lower cost toner charge control agents, and particularly ones that would offer benefits over current commercial materials.

Electrostatic charging of toner (usually referred to as “triboelectric” charge after the Greek word “tribo” meaning “to rub”, occurs when toner contacts a second component carrier or other charging surface. This toner charging is a surface phenomenon dependent on the physics and chemistry of both the toner and charging surface. In single component developers this charging surface can be a metering blade or charge roll, often coated with polymers or specialty chemicals that can influence toner charge. In dual component systems a separate carrier particle serves a dual function of charging and transporting toner. The carrier surface is typically coated with polymers that provide both durability and at least some degree of toner charging. While toner charging can be influenced by the secondary charging surface, it is usually the toner composition itself that has the greatest influence on most charge properties. Toner polymers, for example have a certain intrinsic charge that could be positive or negative, depending on its composition. Usually those binders are various styrene acrylic or polyester compositions and the vast majority have a tendency to charge negative. Inclusion of carbon black in a toner can raise this negative charge magnitude, particularly if the carbon has acidic functionality. However, addition of carbon black will not usually provide fast charge rate, particularly when admixing new toner with existing toner. Likewise, carbon black alone will not change the charge polarity. In addition, carbon black is not suitable for color toners. Another technique to influence toner charging is to attach particulate additives to the toner surface.

While the materials and techniques described above can serve to modify toner charge, they are often not sufficient to provide the complete range of charge polarity, charge magnitude, charge rate and charge stability. A solution, seen in almost all current toners, is to include specialty chemical charge control agents within the toner composition. A typical toner preparation process would involve combining the desired polymers, pigments, wax, charge agent and any other internal additives and first dry blending in a high intensity mixer. Those ingredients are next melt mixed using an extruder, 2-roll mill, Banbury or similar compounder. The compounded toner is milled to a desired size using jet or mechanical mills. That fine powder is typically air classified to the desired particle size distribution. For most toner applications one or more fine particulate additives are then mixed with the toner. The amount of charge control agent traditionally used in these formulations may range from 0.5 to 4% or more, depending on the charge rate, charge magnitude and charge distribution desired.

The mechanism by which internal toner charge control agents work is not always well understood, and may differ depending on the charge agent composition and specific carrier or charging surface. Many authors have postulated electron exchange mechanisms based on “work function” differences between toner and carrier. Based on this mechanism, electron accepting functionality such as COOH, CONR₂, SO₃⁻, will predominantly tend to increase negative charging of the toner. Other researchers have postulated that ion exchange is the dominant mechanism of charge control function. Thus, substances that can release OH⁻ or attract H⁺ would tend to charge positive. Proton donors or OH⁻ acceptors would increase negative charging. Investigations of certain ionomers by Diaz showed that mobile anions can transfer to carrier surfaces. He also concluded that higher charge is obtained where one species is mobile as opposed to when both anion and cation are mobile. This theory helps explain the differing charge behavior of similar azo dyes. Many chromium based azo dyes have been claimed as negative charge control agents. However, the most effective metal complex azo dye structures have small, mobile cations such as hydrogen, sodium or ammonium. Functional groups such as nitro that help to delocalize the charge within the larger anion also appear to improve azo dye charge control function.

To be suitable as a toner charge control agent, a chemical material must meet a great many criteria. This has proven to be a difficult goal to meet as many materials will have one or more positive attributes but fail to achieve in other critical areas. In general, an ideal charge control agent would possess the following characteristics. Correct charge polarity is the most obvious attribute. High charge magnitude is usually desirable as it will allow moderate concentrations of CCA to be used. High concentrations are undesirable both because of excessive expense but also because the CCA may adversely affect toner rheology, mechanical, or electrical properties. Excessively high charge magnitude can also be disadvantageous as low concentrations of CCA would be required and this can be difficult to uniformly disperse. Ideally the charge magnitude will have a relatively small concentration dependence to facilitate uniform toner production. The electrostatic charge should remain stable over time, amount of mixing, and changing environmental conditions. The charge agent should provide good toner “ad-mix”, where fresh toner can be combined with existing toner and rapidly achieve stable charge. A charge agent must be thermally stable to toner processing conditions. A charge agent should be readily and uniformly dispersed within the binder resin. Poor dispersion can contribute to free charge agent particles that can contaminate photoreceptors, charge rolls, developer rolls or carrier surfaces. Additional desirable characteristics include low electrical conductivity, no interaction with machine components and non-migrating or blooming. Color toners will obviously require colorless (or the same color as the toner) charge control agents. Finally, charge agents should be of reasonable cost.

A great number of chemical materials have been patented and/or sold as a charge control agents. Among the most popular positive charge agents have been the family of aniline dyes better known as nigrosines, typified by Solvent Black 7. Nigrosine base may also be reacted with hydrochloric acid to produce an alcohol soluble variety. A sulfonate salt is Acid Black 2. Frequently the nigrosine base is reacted with stearic or oleic acid to improve polymer dispersibility. Nigrosines were among the first positive charge agents and still find extensive use today. They offer high charge, low cost and some tinting value. Disadvantages include toxological concerns, difficulty in achieving narrow charge distributions and their dark color, which presents a problem for color toners. Other basic dyes such as triarylamines exhibit high positive charge and are more environmentally friendly, although they are also dark colored and not suitable for color toners. Colorless quaternary ammonium salts such as tetrapentyl ammonium chloride were first patented by Eastman Kodak during the early 70's as positive charge agents. Since that time an extensive array of colorless quaternary ammonium and phosphonium salts have been patented and used commercially. They offer advantages for color toners, are environmentally friendly, and can be relatively inexpensive. Quaternary salts are not without their disadvantages though. Electrostatic charge magnitude is not necessarily very high, heat stability can be an issue, charge rate is not always fast, and they can be more sensitive to humidity. Polymeric quaternary ammonium salts are another option for positive charge toners, but again, their charge magnitude may not be as high as desired.

It was mentioned earlier that most typical polymer/pigment combinations inherently charge negative. Thus it would not be immediately obvious that charge control agents would also be desired for negative charge toners. However, the demands of modern EP systems require fast, uniform, and stable charging. It was discovered in the mid 70's that certain chromium complex azo dyes could contribute to rapid, stable and high magnitude electrostatic charging. The most effective of these early dyes were nitro-substituted versions with hydrogen or ammonium cation such as Acid Black 63. These dyes were highly colored and had other disadvantages, particularly the fact that they often showed a positive Ames test indicating that they may be a possible mutagen. Improved chromium complex dyes such as Hodogaya's Spilon Black TRH were later introduced (U.S. Pat. No. 4,433,040 to Niimura) and are among the most popular current negative charge agents used by the toner industry. These dye structures have delocalized electrons and mobile cations such as hydrogen, ammonium and sodium that contribute to higher negative charging. Although the charge characteristics of this azo dye are very effective, it is not without disadvantages that include high cost, its dark color and the fact that chromium is present. Certain iron complex azo dyes have also been found to function as toner charge control agents and these would be considered more environmentally friendly. One example is T-77, sold by Hodogaya Chemical. While this material does not contain chromium and thus is more environmentally friendly, it's charge control properties are not always as effective as certain chromium based charge control dyes, particularly when used with iron oxide-containing single component toners. It is not clear if this difference in performance is related to dye chemistry, degree of dispersion, or some other interaction with toner components. In U.S. Pat. No. 5,439,770 Taya teaches that using an acid functional polymer binder with an iron complex charge agent will provide improved charge properties. In U.S. Pat. No. 6,090,515 Tomiyama teaches that inclusion of a long chain alkyl compound with iron based charge agents will provide improved toners. The long chain alkyl compound has terminal —OH or —COOH groups and from 35 to 150 (—CH2-) groups. In U.S. Pat. No. 6,120,958 Ookubo teaches that a particle size of 6-15 microns is preferred for an iron based charge control agent. While these techniques can sometimes be used to improve the performance of an iron based azo dye charge agent in specific toner formulations, they are not universally acceptable in providing all of the desired toner charge characteristics with other formulations. In addition, excessive quantities of charge agent may be required and this leads to high toner cost.

For many color toners a colorless or lightly colored charge agent is required. One group of commercial colorless charge control agents comprise zinc, aluminum, chromium, or zirconium metal complexes offered by Orient Chemical, Hodogaya Chemical and others. Environmentally friendly polymeric or non-metal complexes are also available from Fujikura Kasei and Clariant. While these colorless or lightly colored compounds may improve the charge performance of many toner formulations, the charge rate and charge magnitude are frequently inferior to that which can be obtained by the highly colored chromium based azo dyes, and thus higher quantities may be required. These colorless compounds can also be significantly more expensive than most colored charge agents.

One option for overcoming some of the challenges of using internal charge control agents has been to use ultrafine particles on the surface of a toner as disclosed by Chatterji in U.S. Pat. No. 3,720,617. A wide variety of metal oxides, fine polymer particles, metal stearates and miscellaneous powders are commonly added to toner surfaces. These powders are usually added to improve powder flow as well as assist in photoreceptor cleaning, but they can also be used to modify toner charge. Among the most common of these additives are the silicon, aluminum and titanium metal oxides. These particles typically have an ultimate particle size of from 10 to 50 nm, with some new varieties being as large as 200 nm, however as size becomes larger it is more difficult for the particles to adhere to toner surfaces. The metal oxide particles are usually treated with silicone oil and/or silanes and titanates to control their charge and hydrophobicity.

It is possible to treat these ultrafine inorganic particles with other compounds to influence their electrostatic charge. For example, Hashimoto in U.S. Pat. No. 4,828,954 discloses treating the surface of fine particle size silica with an onium salt. Gruber in U.S. Pat. No. 4,965,158 discloses improved toners where charge enhancing additives are sorbed on the surface of flow additives. Miyakawa in U.S. Pat. No. 4,576,888 discloses a dye bonded to silica using an aminosilane coupling agent. Another patent describing ultrafine silica treated with a material to alter its charge is U.S. Pat. No. 5,178,984 where Nagatsuka treats ultrafine silica with a copolymer. Law in U.S. Pat. No. 5,482,741 treats ultrafine silica with charge agent solutions. Little in U.S. Pat. No. 5,900,315 produces charge-modified metal oxides by treating fine metal oxides with cyclic silazanes. In each of these patents the silica is significantly less than 100 nm and intended for use as a toner surface additive, rather than be included in a toner composition as traditional charge agents are used. While externally added, treated, fine size metal oxides may improve the charging behavior of some toners, they do not satisfy all the charging requirements. Externally applied, treated metal oxides can be sensitive to high humidity with a resultant diminished print quality. The externally applied particles can also separate form toners during use and contaminate machine components as well as alter the toner charge. These ultrafine particles are also not suitable as internal charge agents because their small particle size tends to dissociate charge rather than create localized charge centers. U.S. Pat. No. 5,674,655 to Guistina discloses toner compositions where an ultrafine metal oxide is blended in a toner. However, the intended application is for odor control.

Despite the availability of numerous commercial charge control agents, there continues to be a need for improved materials for both traditionally prepared extruded toners as well as new directly polymerized versions. As mentioned earlier, many typical charge agents are dyes, pigments or organic chemicals and are available as relatively large agglomerates. Toner preparation processes may break up these agglomerates to some degree but excellent dispersion is often difficult to achieve. Non-uniform dispersion results in excess charge agent in some particles and an insufficient amount in others, resulting in toners that provide non-uniform image quality and a reduced efficiency. In addition, the charge control agent can be the most expensive component of a toner and it would be desirable to be able to maintain its functional quality while reducing the quantity used. Another desired improvement would be a technique for manipulating the charge magnitude of specific charge agents without changing the total quantity of charge agent used. In this way a set of color toners could achieve similar charge characteristics using the same material. Finally, it would be desirable for a charge agent to function both in conventional as well as direct polymerization processes.

U.S. Provisional Patent Application 60/937,967, the content of which is totally included in this application, discloses a process for preparing novel and improved electrostatic charge control agents. The disclosed process involves formation of composite charge control agents by impregnation of porous inorganic cores with at least a polymer or wax and one or more charge control chemicals. The concept of using relatively large size precipitated silica or inorganic particles as carriers of various liquid or polymeric compounds is well known. For example the H.M. Huber web site mentions that various inert powders such as silica, calcium silicate and calcium carbonate can function as excipients for fast-dissolving oral dosage tablets. Zucker in U.S. Pat. No. 4,344,858 discloses treated silica particles to serve as anti-foaming agents. Krivak in U.S. Pat. No. 4,717,561 discloses 0.14 to 0.84 mm silica as a carrier of vitamins. Meier in U.S. Pat. No. 5,321,070 discloses silica treated with resorcinol compounds as rubber adhesion promoters. Durand in U.S. Pat. No. 4,298,472 impregnates anhydrous silica with polar organic compounds to modify its adsorbent properties. Hench in U.S. Pat. No. 5,356,667 utilizes a porous silica to adsorb a laser dye. Xu in U.S. Pat. No. 5,555,813 uses molecular sieves to function as a carrier of a dye. Hi-Sil 223 silica, commercially available from PPG Industries, is used to absorb hexamethoxymethyl melamine resin as an adhesion promoter for wire. There are also numerous patents describing treated silica for use as polymerization catalysts. It is also known to treat relatively large size pigment particles to improve their dispersion or electrostatic charge properties. U.S. Pat. No. 5,401,313 to Supplee discloses techniques to treat iron oxide particles with surface inorganic chemicals and dispersion promoting agents to improve their electrostatic charge for incorporation in such products as concrete or magnetic toners. U.S. Pat. No. 5,288,581 to Ziolo discloses anionic clay or clay-like charge enhancing additives. A similar patent U.S. Pat. No. 7,309,558 to Michel teaches modification of clay-like particles to produce electrostatic charge control agents. While these treated pigments may be suitable for their intended purpose, each would not satisfy the main advantages provided by the inventive novel composite charge control agents. First, the specific organic or inorganic surface treatments mentioned in these patents would not provide the flexibility to improve almost any existing commercial charge control agent. In both of the above named patents a relatively nonporous pigment is surface treated with agents to alter their electrostatic charge. These surface treatments must by necessity be relatively thin or monolayers of chemical agents. However, the majority of current commercial charge control agents exist as larger crystals that could not be applied as thin coatings. Second, a simple surface treatment of inorganic particles does not provide a means for incorporating additional toner-related components such as a wax or polymer. Third, they do not provide a convenient means of adjusting the particle size of a charge control agent to almost any size desired.

While improved electrostatic charge control agents is a first object of the current invention, the process is significantly more versatile and can be used to prepare other composite imaging materials.

A second objective of the inventive process was to be able to use the same core impregnation process with additional components and provide an improved technique for preparing high wax content toners as well as a wide variety of toners and specialty powders that can not easily be prepared by existing processes. For example, it would be desirable to formulate toners using low melt viscosity, flexible binders, particularly for high quality color systems. However, air and mechanical milling processes are not suitable for flexible binders. A third problem with traditional extrusion/milling of color toners is the necessity of either four expensive production lines or fewer lines that must be cleaned between colors. Also, it would be desirable to produce both positive and negative charge toners using the same equipment, again without extensive clean up.

A more thorough explanation of toner wax use will illustrate the unique advantages of the current invention. From a historical perspective, the first copiers used non-contact radiant or oven fusing to soften low melt viscosity toners. A disadvantage of those systems was inadequate paper adhesion, raised images, and occasionally, paper fires. Most modern electrophotographic engines use heat/pressure rolls to soften and force the toner into paper fibers. Optimum fusing occurs when all toner adheres to the paper. A problem can occur if the complete toner layer softens but the layer splits, resulting in some “toner offset” to the hot roll fuser. To a limited extent this can be cleaned by wipers or blades. More typically, hot offset toner can transfer to undesired front or rear paper surfaces. One option to reduce hot offset has been to equip fuser rolls with a silicone oil lubrication system. Such systems can be messy and complex and are today commonly used only in some color and high speed printers. A novel solution to this issue was the use of fuser rolls with silicone or fluorocarbon release surfaces in combination with high cohesive strength polymers. However, this alone did not completely solve the toner release problem. U.S. Pat. No. 4,481,274 to Canon describes how addition of 0.1 to 5% olefin homopolymer or copolymer can provide good toner release. The practice of including sharp melting point wax release agents in toner formulations is now common for most black toners. Although this solution is usually quite adequate for producing a wide variety of black toners it presents challenges color toners.

Color toners are typically prepared using low melt viscosity polymer binders and these provide poor release of the toner from non-lubricated fuser rolls. Many full color systems have resorted to use of high concentrations of internal wax lubricants or release agents in a toner. However these lubricants are not usually compatible with toner polymers and they reduce shear in melt extrusion, thus making toner preparation difficult. An additional problem of toners containing melt mixed wax lubricants is that the incompatible wax may separate from the toner during milling operations. The wax particles form satellites that can adhere to toner surfaces. During the electrophotographic process these wax particles may separate from the toner and adhere to such machine components as charge rolls or photoreceptors, with resulting degradation of print image quality. Polymer/wax compatibilizers are sometimes included in a toner composition to minimize this problem but this does not provide a completely satisfactory solution.

Numerous patents have been issued describing solutions to the above toner issues. For example, use of encapsulated toners to solve some of the above problems is frequently described in the art and include such processes as spray drying, coercivation, phase separation, and interfacial polymerization. For example U.S. Pat. No. 3,080,251 to Claus discloses core/shell capsules with a liquid in the core. No inorganic compound or wax was present in this toner. More recently the issue of incorporation of large amounts of wax in toner formulations has been addressed by formation of core-shell toner particles using dispersion polymerization or coagulated emulsion processes. In dispersion polymerization, the wax, pigment, and a polymer binder are formed into core particles and subsequently encapsulated by a secondary polymerization process. Although suitable for some purposes this process is extremely limited in the types of polymer components that can be used. For example a flexible polymer can not easily be applied as a shell. The process is also quite complex, requiring expensive equipment both for the toner production and containment of waste streams.

Coagulated emulsion processes involve formation of polymer and wax emulsions, pigment dispersions, and optionally additional toner components and then coagulating to a desired size. Again, this process can be an improvement over traditional processes, but it also has many limitations. Polymer choice is limited to those that can form emulsions and the specific emulsification agents can result in toner particles sensitive to moisture and whose electrostatic charge varies with environmental conditions. For either of the polymerization processes described above there are disadvantages related to the large amounts of waste water required for washing the particles and the extensive time required to dry the particles.

Another technique for producing high wax content particles has been referred to as chemical milling. This technique involves shear mixing of colorant, polymer, wax and plasticizer in an aliphatic solvent. It offers some advantages over other chemical techniques in being able to use polyester resins and dyes. However it is complex, particle size control is difficult, and the raw material choices are limited. A more detailed description of these processes can be found in the references. While each of these alternative toner preparation techniques may provide certain advantages over traditional processes, none of them provide a completely adequate solution for small particle size, high wax-containing color toners.

The inventive process does provide one relatively simple solution to the above mentioned problem of higher wax content toners. Impregnation of inorganic cores by a wide variety of waxes is readily accomplished. By judicial selection of the inorganic core particle size, pore volume and surface area, a relatively large quantity of wax-impregnated particles could be prepared and either incorporated within a conventionally prepared or chemical toner composition. Alternatively, relatively small wax-impregnated particles could be prepared as toner surface additives.

Pigmented powders containing wax by themselves are not novel and have been prepared by a number of techniques. Some examples include U.S. Pat. No. 3,674,736 to Lerman, which discloses a dispersion process where a pigmented polyolefin is heated with agitation in the presence of a surfactant. This technique is not suitable for preparing particles of appropriate toner composition within the 3-10 micron toner range. In U.S. Pat. No. 4,912,010 Mori discloses a high wax content, encapsulated toner prepared by dissolving a release agent in heated monomer solution, cooling the solution to precipitate the wax and then aqueous suspension polymerization of the monomer to form a shell. This process is capable of preparing high wax content toners but the dispersion polymerization process does not have the flexibility to prepare toners with polyester binders or ones with narrow particle size distributions. In addition, many dyes, pigments and charge agents can inhibit dispersion polymerization. U.S. Pat. No. 6,514,487 to Kasuya discloses a process for dispersion polymerization in the presence of anti-offset agents. Again, use of an inorganic core of approximately the same size as the desired toner was not used as a wax carrier and the dispersion polymerization process suffers from the same disadvantages as the U.S. Pat. No. 4,912,010 patent.

Incorporation of wax in or on silica is also known. U.S. Pat. No. 6,921,781 and other patents disclose processes for covering silica with wax. These references typically involve gaseous deposition processes. In each of the patents listed above there was no indication that the inventor anticipated incorporation of pigments and wax or olefin-like polymer in the particle for a toner or the use of an inorganic core of approximately toner size to prepare a finished toner, toner charge control agent or related imaging powder.

### SUMMARY OF THE INVENTION

A first object of the present invention is to provide a simple process that can overcome problems related to producing toners and specialty powders that contain large quantities of wax. A second object of the present invention is an inexpensive toner preparation process suitable for a wide variety of conventional and novel toners. A third object of the present invention is to create a process for economically preparing a wide variety of dyed, pigmented, or treated particles that can function as electrostatic charge control agents. A fourth object of the present invention is to provide a process for preparing colored decorative or security marking particles.

The objectives described above were achieved by the use of porous inorganic core particles of approximately the size desired of a finished toner or powder. The core particles are impregnated with various components selected from polymers, wax, pigments, colorants, charge control agents, or specialty chemicals. The process may involve coating or adsorption of such ingredients from solvent solutions, emulsions, or dispersions. Optionally, a shell can be formed on the impregnated core by a second adsorption/drying step. The impregnated particles are typically dried to form a toner or specialty powder, although it would also be possible to use the particles in dispersion form as liquid toners. Additional steps such as classification or surface additive addition are conducted as required, depending on the final toner or powder requirements. The invention also allows for the impregnation of smaller size inorganic particles which can then be aggregated to a desired size by using a precipitation technique.

### DETAILED DESCRIPTION

The basic concept of the inventive process is to first obtain an inorganic core particle whose particle size is approximately the same as that desired of the final toner, charge control agent or other imaging powder. That core particle is then impregnated with a combination of chemicals required to provide appropriate chemical and physical properties of the desired final powder.

A first implementation of the inventive process is the production of novel composite charge control agents by impregnating a suitable inorganic core with at least a polymer or wax and at least one or more organic charge control chemicals.

Suitable charge control agents include, but are not limited to, amino acids, basic dyes, organo boron complexes, polymeric amines, metal complex dyes, acid dyes, non-metal dyes, and salicylate metal complexes. An extensive list of commercially available charge control agents is available in the reference work Toner Raw Material Handbook and Information Service published by Toner Research Services. In each case the particle size of the charge control agent is reduced to a size significantly smaller than the inorganic core particle size, and preferably below 1 micron. If the charge control chemical is in the form of a large particle size powder, its size can be reduced by any common dry or wet milling operation and could include use of a dispersant to maintain the milled particles in a dissociated state. It is also possible to obtain a charge control chemical in a wet press cake form and such a material could be flushed into an appropriate solvent, wax or polymer.

A suitable porous core particle is readily available porous, amorphous silica, alumina or titania. The inventive process may be carried out with a broad range of particle size cores ranging from approximately 0.2 micron to 10 microns or more, depending on the particle size of the desired toner or powder that the charge agent will be used in. If the particle size of the core is too small a pigment charge control agent is not adsorbed on the core but will instead exist as separate particles. It is also not desirable to have the core similar in size to that of the toner, unless the formulated charge control agent can be broken into smaller aggregates during toner melt mixing operations. The optimum size core will vary with a particular toner, the surface area of the inorganic core and the charge level desired. In general, a particle size within the range of 0.5 and 5 microns is preferred for most toners. Air classification of the core particles can be used to produce a desired particle size or size distribution if it is not available commercially. The surface chemistry and pH of the core can also play a synergistic role in the composite charge agent. For example, inorganic cores with acidic surface may contribute to higher negative charging of the composite agents while basic cores may be preferred for positive charge agents. Thus, specific surface treatments may also be applied to adjust the core particle charge, conductivity or its hydrophobicity. Surface area and pore volume of the inorganic core was also found to play an important role in charge agent performance. In general, higher surface area cores with larger pores will allow for adsorption of higher quantity and smaller particle size charge agents. Suitable inorganic cores in various particle size ranges are commercially available from such companies as Ineos Silica, Fuji Sylysia, Rhodia, Rhone Poulenc, PPG, J.M. Huber and Degussa. Preferred are the amorphous silica, alumina or titanium oxides.

One function of the wax or polymer is to act as a binder for the charge control chemical. A second function is to reduce moisture sensitivity of the porous core by filling pores. In general, any wax or polymer that is solid at room temperature and can be formed into a solution, dispersion, or emulsion can be suitable for this implementation. However, to achieve the maximum benefit from the inventive process it is preferred to choose a wax or polymer binder that offers some synergetic benefit to the toner charging or other toner property. For example acidic groups on the wax or polymer can increase negative charging while basic groups can contribute to higher positive charging.

The quantity of polymer or wax binder used will depend on its desired functions. If the function is simply to bind the charge control agent to the core, a minimal amount of wax or polymer may be desired. However, it is possible to use this process as a convenient method of incorporating some or all of the wax commonly used as an internal toner lubricant. The majority of current toners contain from 3% to as much as 10% or more internal wax lubricants that act as release agents for hot roll fusing systems. As the toned image contacts heated fuser rolls the wax melts and coats the rolls. However these lubricants are not usually compatible with toner polymers and they reduce shear in melt extrusion, thus making toner preparation difficult. An additional problem of toners containing melt mixed wax lubricants is that the incompatible wax may separate from the toner during milling operations. The wax particles form satellites that can adhere to toner surfaces. During the electrophotographic process these wax particles may separate from the toner and adhere to such machine components as charge rolls or photoreceptors, with resulting degradation of print image quality. Polymer/wax compatibilizers are sometimes included in a toner composition to minimize this problem but this does not provide a completely satisfactory solution. Use of wax-coated inorganic cores can be an effective method of providing uniformly distributed wax within a toner as the particles disperse much easier. Wax coated inorganic cores can also allow the use of significantly lower concentrations of wax.

A number of techniques can be used to impregnate the inorganic cores with the above composition. First, the charge control agent can be dispersed in an aqueous or solvent system where the wax or polymer is dissolved, dispersed or emulsified. That mixture is then sprayed onto a fluidized suspension of the cores, and the composite particles dried by known techniques. This is accomplished by using such devices as fluid bed, V-cone blender, etc. A second option is to adsorb the dispersion on a quantity of inorganic core particles and then, optionally, dry the composite particles. The quantity of inorganic core particles is approximately the amount required to absorb all of the fluid. A third technique for forming the composite particles is to use a solvent precipitation process as described in U.S. Pat. No. 3,971,749 to Blunt. A wide variety of wax, olefin and hydrocarbon polymers can be dissolved in such heated hydrocarbon fluids as odorless mineral spirits, Magie oils, paraffin oils or other hydrocarbon fluids and when cooled the wax or polymer precipitates. Some examples of polymers suitable for this purpose are most waxes, polyethylenes, propylene, high ethylene content ethylene-vinyl acetate polymers, and hydrocarbons such as Picco 5120 (Hercules). For this implementation the preferred hydrocarbon fluid is one that is environmentally friendly, will dissolve the wax or polymer, and can easily be evaporated. The quantity of fluid used is approximately the amount required to completely wet the inorganic core. An excess of fluid could technically be used although that requires more time and effort for its evaporation. A fourth technique for forming the composite particles is to form a solvent solution of charge control agent and polymers and either spray or adsorb the solution on the inorganic cores as already described. For this implementation a wide range of fluids are possible, including hydrocarbons, acetone, toluene, and environmentally friendly bio derived fluids. For this implementation a relatively small amount of charge dye can be used as the polymer/dye mixture is predominantly adsorbed on the surface of the inorganic core. This implementation is especially useful for preparing colored charge control agents or ones that may use solvent soluble organic chemicals such as quaternary ammonium compounds.

The techniques described for forming composite charge control agents can also be used to produce more complex charge control agents. Thus, additional modifying agents may be included during any one of the above processes. For example, conductivity modifying agents, colored dyes, IR or UV-absorbing dyes or pigments can be included in the compositions to either adjust electrostatic properties or provide an additional security or identification features.

The inventive process provides a technique for preparing novel composite charge control agents with advantages over traditional charge control agents. First, it is very versatile as almost any dye, pigment or organic chemical capable of altering toner charge could be coated or impregnated in the core. For example, a wide variety of colored charge agents are possible. Also, both positive and negative charge control agents can be produced. The technique also provides a simple way to produce complex charge agents in that mixtures of charge chemicals and optionally conductive or modifying components can be included in the particle. The technique provides a simple method of producing charge agents with almost any desired size. The technique also provides a method of lowering the cost of charge control agents, one of the most expensive components of a toner. This benefit is based on the fact that a small amount of active charge agent chemical is contained primarily on the inorganic core, which typically has very high surface area. For example, it is possible to impregnate the inorganic core with as little as 25% or less of an expensive, commercially available charge agent and achieve the same toner electrostatic charge. Another unforseen benefit for the composite charge agent was the use of wax as the charge agent binding component. By proper selection of the wax, improved toner fixing and anti-offset can be achieved when compared to toners without the wax. By judicial selection of the type and quantity of wax used for these novel composite charge agents it may be possible to reduce or eliminate use of additional wax in the toner. This would provide a significant benefit in terms of toner preparation, but an even greater benefit in that it could reduce the amount of free wax particles that tend to accumulate on charge rolls and photoreceptors. This unexpected benefit is possible because the small particle size and high surface area of the inorganic cores provides a large amount of effective surface area to be coated with wax. The composite charge control agents have also been found to disperse much easier during melt mixing as compared to conventional charge agents and this can improve toner processing rates. The composite charge agents can also be safer to use. Certain charge control dyes are potentially flammable but this would be reduced when adsorbed on an inorganic core.

Any of the above charge control agents can be used in the same manner as traditional charge control agents. For melt mixed toners the amount of inventive charge control agent may range from 0.5 to 4% or more, depending on the charge rate, charge magnitude and charge distribution desired. The inventive composite charge control agents can be designed to have the same charge characteristics as traditional charge agents such that they are used at the same concentration. However, it is also possible to design the inventive charge agents to have superior charge properties that result in improved performance at lower concentration levels. Likewise, the charge agents can be designed with lower charge magnitude such that higher concentrations are used. This can be an effective technique for achieving more uniform toner charging or incorporation of higher wax concentrations. Because the composite charge agents are less expensive to produce the higher concentration would not add to toner cost.

The inventive charge control agents are not limited to use only in conventional dry toners. A variety of non-traditional processes are currently being used to produce toners. These include such techniques as suspension polymerization, aggregated emulsion, solvent milling, evaporative coalesence and others. Each of these toners must also achieve certain levels of charge magnitude, charge rate, and charge stability. Inclusion of traditional charge control agents in most of these processes has been difficult, at best, so that the toner producer frequently relies on external additives to control toner charge. While this may provide an adequate technical solution for these so-called chemical toners, relatively large amounts of expensive additives are required. These additives can present difficulties in EP hardware as they frequently separate from the toner and collect on drums, charge rolls, developer rolls or cleaning blades. In addition, these ultra fine additives can become airborne during use and present possible environmental issues. The inventive composite charge control agents can be easily used in many of these processes because.

The inventive charge control agents are suitable for applications in addition to toners. Electrostatic powder coating also relies on charged powders. Until recently this industry did not adequately concern itself with carefully controlling the powder charging, resulting in inefficient and wasteful spraying. The inventive composite charge agents can be especially beneficial for this process as versions can be produced at low cost and with great versatility.

It has already been described how the inventive process can be used to impregnate inorganic cores with wax or polymer and a charge control agent. By substituting a colorant for the charge agent a simple toner can be prepared by impregnating a suitable core. For this implementation the core size would be in the range as the desired toner, typically from 3 to 10 microns. Characteristics of the core particle important for the process include particle size, particle size distribution, pore structure and surface chemistry. The particular core particle shape is not critical as the inventive process can be controlled to provide various end particle shapes ranging from spherical to irregular and the end particle surface can be controlled to range from smooth to rough. Mechanical strength of the inorganic core can be of importance for some toners. For example some development systems will require a very tough and mechanically strong toner. There may also be processes where it would be desirable for the core to fracture during the toner fusing process. If necessary, the inorganic core may be first classified to the desired size range. A surface treatment may also be desired to adjust the core particle charge or hydrophobicity, and this could be incorporated either initially or as a final step. The colorant can be a dye, color pigment, carbon black or magnetic oxide. The polymer could be any one that was either dispersible in water or soluble in a desired solvent. The particular impregnation process would depend on the type solvent chosen. For example, a toner could be prepared by forming an aqueous dispersion of pigment, polymer and additional components such as wax and charge control agent and impregnating the cores as already mentioned. Alternatively, a polymer or wax could be precipitated in the presence of a dye or pigment.

It is also possible to use multiple steps to impregnate the core. A colorant or specialty chemical may be added to the core as a first process step by adsorbing a dye/chemical solution or pigment dispersion and optionally conducting a first drying operation. More typically the colorant and/or additional components are added during the main impregnation step when the wax/and or resin is adsorbed into the amorphous core. If using the wax/polymer precipitation process it is possible to add a second resin that also dissolve in the fluid at elevated temperature and which may or may not precipitate upon cooling. Depending on the solubility parameters of the dissolved resin and wax it is possible to obtain cores that are impregnated with wax, polymer or wax and polymer. If the second resin precipitates after the wax a shell will form, encapsulating the wax impregnated core. Certain hydrocarbon resins such as Picco 5120 (Hercules) are suitable for this purpose. Optionally the second resin could remain soluble and coat the silica/wax particle upon subsequent drying. A resin that meets these requirements is a cyclic olefin polymer sold by Ticona under the Topas trade name. Alternatively, a polymer and optionally charge control agent could be added as a separate shell. One such method involves dissolving the additional components in a solvent such as acetone that does not dissolve the wax. The polymer solution is adsorbed onto a wax or colorant impregnated silica core and the solvent evaporated. Alternatively, addition of a non-solvent could be used to precipitate a polymer onto the impregnated core. Another method of producing the polymer shell is by adsorption of monomers and polymerization by bulk, solution, dispersion or interfacial techniques in either aqueous or hydrocarbon fluid. A shell can also be formed on the impregnated core by blending the core with fine polymer particles that adhere to the core by electrostatic or thermal means.

As can be readily seen from the previous discussion, the inventive process provides numerous benefits for the production of a wide variety of electrostatic toners and toner additives. First, the process is very versatile. A wide variety of charge control chemicals, waxes, lubricants, polymers, colorants or specialty chemicals can be impregnated in the porous core particles. For example virtually any type dye or pigment could be adsorbed in the core, either with or without additional polymer or modifying components. Encapsulation with a polymeric shell by techniques described in this invention will isolate the colorant from the toner surface, preventing undesirable charge interactions or contamination of hardware components such as the photoreceptor. Significantly, a broad range of polymers can form the shell of such particles since the shell forming process does not necessarily rely on polymerization techniques. This is not true for competitive toner polymerization processes where wax is included in a core. Secondly, the inventive process can be low cost. Core particles are prepared in large quantity by conventional techniques. Typically a commercially available base core particle is either readily available or can be classified to a size distribution desired for a specific toner or specialty powder. The same core can then be used for a wide variety of color toners having the same particle size. Third, the process is very safe. There are no dangerous solvent byproducts produced and no waste streams of liquids to be treated as might be the case with certain polymerization processes. Solvents used during the inventive process can be environmentally friendly or easily collected and recycled. Fourth, the inventive process is capable of providing unique composite toner and powder compositions not easily prepared by any other technique. Also, the use of low specific gravity, porous cores can provide unique toner properties. When impregnated with wax/pigment and coated with a shell resin the toner particle is not completely solid. When fused the wax/resin components tend to flatten and not spread out, resulting in improved images. The composite toners can also provide higher print yields as the particles could be designed to be not completely solid. Also, it may be desirable with certain toners to include a small amount of low-volatile, environmentally friendly fluid to be retained within the core. During the fusing process this fluid is heated and can solvate the wax and optionally the shell resin, providing high gloss images. It would also be possible to entrain a volatile hydrocarbon liquid within the core, which when heated could expand a polymer coating, producing raised images.

The inventive process is especially useful as a simple in-situ technique to prepare liquid toners. By using a core of approximately 1-2 microns and impregnating the core by precipitation process in hydrocarbon fluid, a liquid toner is directly prepared.

A third implementation of the inventive process is the preparation of composite security and identification powders. Again, inorganic core particles of approximately the size of the desired final product are impregnated with a specific composition of a visible or invisible colorant and polymer binder. A first example is the use of a solvent solution of IR or UV-absorbing dye and a polymer that is compatible with the dye. The composition is added to a quantity of inorganic core sufficient to adsorb all the liquid and optionally, the solvent evaporated. Small quantities of the composite particles can be added to toners, coating powders, paints, etc. as a means of identification. The particles may also be used as a solvent dispersion without drying. A second example is the use of a dispersion of polymer and phosphorescent pigment that is used to impregnate inorganic cores. Again, the composite particles could be dried and isolated. The composite particles could used be used in a dispersion form as part of an ink or coating.

The following examples are provided as representative techniques for forming composite toners, charge control agents and specialty powders. They are illustrative but are not meant to define limitations of the process. It is understood that those trained in the art could use modifications of the illustrative processes to produce other products.

### EXAMPLE 1

A composite polyolefin powder was prepared as follows. 2 g Black Pearls L carbon and 100 g odorless mineral spirits were milled 1 hour in an attritor using small steel shot and the shot separated. 18 g of maleic-modified polyethylene was added to the pigment dispersion and the mixture heated to approximately 130 C. Separately, a portion of Fuji Silysia silica was air classified and the portion under three microns collected. The polymer pigment dispersion was added to a quantity of the silica particles approximately sufficient to adsorb all the liquid. Heat was removed and the mixture cooled. The precipitated powder was dried to form a black, pigmented polyolefin/silica composite powder of approximately 2 micron size that was useful as a toner surface additive or liquid toner.

### EXAMPLE 2

This example demonstrates the preparation of an encapsulated pigment/silica core toner particle by precipitation process. A pigment dispersion was prepared as in Example 1, except that Pigment Blue 15:3 was substituted for the carbon. The cyan pigment dispersion was separated and combined with 10 g Fuji Sylysia 456 amorphous silica of approximately 8 micron size. 10 g of maleic-modified polyethylene was added to the pigment dispersion and the mixture heated to approximately 130 C. Heat was removed and the mixture stirred while cooling. The precipitated powder was washed and vacuum dried.

### EXAMPLE 3

This example demonstrates the preparation of a composite toner by aqueous process. A cyan pigment dispersion was prepared by milling 25 g of BASF Heliogen Blue L7460 and 150 g distilled water. The dispersion was separated to provide 300 g of dispersion. 24 g of the above dispersion (equal to 2 g pigment), 16 g of a 25% aqueous dispersion of carnauba wax (Michem Lube 156, Michelman), and 40 g of a 45% Aquamac 700 styrene acrylic emulsion (Hexion Specialty Chemicals) were mixed together. 30 g of air classified (fines removed) Fuji Silysia 460 silica was then mixed with the liquid dispersion, forming a paste. The mixture was dried to provide an 11 micron toner.

### EXAMPLE 4

This example demonstrates preparation of a fine composite wax/pigment particle. Tixosil 1221 silica was air classified and the fine fraction collected. It had a volume distribution of 3.16 microns. Next, the quantity of odorless mineral spirits required to wet the silica was determined. The quantity was approximately 11 g fluid for 10 g of the silica. Next, 5 g Unicid 425 (Baker Petrolite) and 6 g odorless mineral spirits were heated to approximately 110 C, combined with 10 g of the dry Tixosil silica, cooled and air dried to provide a composite wax particle that was useful as a toner surface additive or a wax coated particle that could be used as an internal lubricant with either traditional or chemical toner preparation processes.

### EXAMPLE 5

35 g of Ticona Topas polymer was dissolved in 150 ml Magiesol 44. This was media milled with 10 g Sun 15:3 cyan pigment. To the pigment dispersion was added 10 g Kemamid E wax. The mixture was heated to approximately 80° C. to dissolve the wax. 100 g Fuji 456 Silica was added to the above heated mixture. The mixture was cooled and dried to provide a cyan toner

### EXAMPLE 6

This example demonstrates the preparation of fluorescent powder. 10 g of Ticona Topas polymer was dissolved in 50 ml odorless mineral spirits. 1 g of a blue phosphor pigment was dispersed in the above solution. Approximately 15 g of Rhone Poulenc amorphous silica of about 50 micron average size was added to the liquid dispersion and the solvent evaporated. The resulting powder was compared to a powder prepared by melt mixing/grinding techniques and shown to have significantly higher phosphorescence when exposed to a UV light. This was attributed to the fact that the pigment was probably present on the silica surface rather than throughout a melt mixed/milled comparative particle.

### EXAMPLE 7

A polypropylene wax and Picco 5120 hydrocarbon resin were dissolved in Isopar G at elevated temperature. A cyan pigment dispersion was added. Amorphous silica of approximately 8 microns was added to the dispersion until essentially all the liquid was adsorbed. The mixture was allowed to cool, precipitating both the wax and Picco resin to provide a resin/wax composite.

### EXAMPLE 8

In place of the Picco 5120 resin used in example 8, a crystalline polyester from Ticona was used. The polyester dissolved at elevated temperature and remained soluble upon cooling. The composition was processed as above and the fluid removed by common evaporation techniques.

### EXAMPLE 9

Tixosil 1221 silica was air classified to provide a quantity of particles whose number distribution was 3.16 microns. Separately, 1 g BASF Sudan Blue 670 and 10 g Reichhold Fine Tone T-RM-14 polymer was dissolved in 50 g methylene chloride. 8 g of the classified Tixosil 1221 silica fines was slowly added and the mixture dried to produce a blue powder that was suitable either as a toner charge control agent or cyan liquid toner.

### EXAMPLE 10

0.5 g of Bayer Macrolex Red H dye and 4.5 g Baker Petrolite Unicid 425 were dissolved in 25 g heated odorless mineral spirits. This was added to 14 g Fuji Sylysia grade 460 silica that had been air classified to collect under 5 micron particles. The dispersion was cooled to precipitate the wax and dried to form red composite particles that could be used as charge control agents or dry toners.

### EXAMPLE 11

An experiment was first run to determine the quantity of odorless mineral spirits required to completely wet 10 g or Ineos Gasil 23F silica. This amount was approximately 50 g. Then, 1 g Bayer Macrolex Blue 3R dye, 10 g Mitsui NP 056 wax and 50 g odorless mineral spirits were heated to 110 C. The heated dispersion was added to 10 g of the Gasil 23F silica, allowed to cool, precipitating the wax and then dried to provide a blue toner.

### EXAMPLE 12

A dispersion was prepared by media milling 30 g T-77 charge agent (Hodogaya Chemical) and 110 g odorless mineral spirits. After milling 1 hour, the dispersion was separated and washed with additional OMS and 210 g dispersion collected. 140 g of the dispersion and 20 g Unicid 425 polymer were heated to 110° C. 20 g HP 270 silica was added to the heated dispersion and the mixture cooled and dried. 30 g of the final product was formulated into a toner comprised of crosslinked polyester resin, 40% iron oxide, and 4% polyolefin wax. The toner was jet milled, classified and the tribolelectric charge measured using a ferrite carrier and Vertex blow-off device. The charge at 10 seconds was −16.0 and −21.5 at 20 minutes. A control toner using 1.5% T-77 charge agent had triboelectric charge of −19 at 10 seconds and −17.6 at 20 minutes.

### EXAMPLE 13

30 g of an iron based commercial charge control agent was media milled with 110 g odorless mineral spirits. The milled pigment was screen separated and washed with OMS. 163 g was collected. This was separated into two fractions. 82 g of the dispersion was placed in a 400 ml beaker, along with 18 g additional OMS and 10 g Ineos HP270 silica The mixture was heated to approximately 100° C. and cooled with moderate stirring. The modified charge control agent was dried and processed into a toner comprised of styrene-acrylic resin, 4% polyolefin wax, 40% magnetic oxide and the above charge control agent. Triboelectric charge measurements were made using a commercial device supplied by Vertex, a standard ferrite carrier and mixing for 10 seconds, 2 minutes, 5 minutes and 20 minutes. The charge at 10 seconds was −14.6 and −21.4 at 20 minutes. A control toner using 1.5% of the same iron based charge agent gave charge measurements of −14.7 at 10 seconds and −8.6 at 20 minutes. Print tests using a Hewlett Packard laser printer showed improved quality when compared with the control toner.

### EXAMPLE 14

The second portion of pigment dispersion (82 g) from experiment 13 was combined with 18 g OMS, 10 g Ineos HP270 silica and 15 g Unicid 425 polymer (Baker Petrolite). The modified charge agent was processed as in example 13 and used to produce a toner with the same composition as Example 13. Triboelectric charge was −25.7 at 10 seconds and −33.2 at 20 minutes. This experiment demonstrated improved charge when an acid functional wax was included in the composite charge agent composition. Print tests using a Hewlett Packard laser printer showed improved quality when compared with the control toner.

### EXAMPLE 15

A pigment dispersion was prepared by media milling 7.5 g Ticona Topas polymer, 65 g OMS and 16 g commercial iron base charge agent. The dispersion was separated, combined with 20 g Ineos HP 270 silica and dried. The modified charge agent was used to produce a toner as in Example 13. Triboelectric charge ranged from −17.4 at 10 seconds to −18.9 at 20 minutes

### EXAMPLE 16

A pigment dispersion was prepared by media milling 30 g chromium based charge agent N32 (Esprix) and 110 g odorless mineral spirits. One half of the resulting dispersion (approximately 85 g) was heated with 5 g Unicid 425 as in example 12 above. While hot, 25 g HP 260 silica was added. The mixture was cooled and dried. 20 g (4%) of the finished composite charge agent was used to produce a single component magnetic toner using the formulation in example 13. The toner was mixed with hydrophobic silica and tested in a Hewlett Packard printer. Print sample had excellent density, minimal background and superior gray scale compared to the standard Hewlett Packard toner.

### EXAMPLE 17

A dispersion was prepared by milling 30 g Hodogaya TRH chromium based charge agent with 125 g odorless mineral spirits. The dispersion was filtered and diluted to 350 g with additional OMS. 15 g Baker Petrolite Unicid 425 wax was added and the mixture heated to 100 C to dissolve the wax. 75 g of Ineos HP 260 silica was then added to form a paste. The mixture was cooled and the OMS evaporated to provide a composite charge control agent. Two toners were then prepared using the same styrene acrylic formulation as in example 13 but with charge agent concentrations of 2% and 3%. A control toner was prepared using 2% of the TRH charge agent. Triboelectric measurements of the experimental toners showed q/M values of −14.5 (10 seconds mix time) and −17.4 (2 minutes mix) for the composite charge agent at 2% concentration. The 3% sample showed Q/M of −19.8 (10 seconds) and −22.7 (2 minutes) at 3% concentration.

### EXAMPLE 18

A composition of 16 g Hodogaya TRH charge control agent and 130 g distilled water were media milled for 2 hours, screen separated, and washed, providing 300 g of dispersion. 32 g of Michem Lube 156 (Michelman) was then stirred into the above dispersion. 40 g of Ineos HP 260 silica was slowly added to the resulting dispersion, providing a very slight excess of liquid. The composite charge agent particles were dried and 2% incorporated in a toner composition as in Example 13. The resulting toner was tested in a Hewlett Packard printer and exhibited print quality superior to a comparative toner that had been prepared with 2% of standard TRH charge control agent.

The inventor does not want to be limited to the technique of impregnating the porous particles, the type of porous particles or the size of the porous particles. Also, instead of the charge control agent above many other dyes, pigments, chemicals, or biological components could be impregnated in the porous inorganic core to provide composite particles.

What is claimed is:

1. A process for producing composite charge control agents, toners and imaging powders whereby a porous inorganic core particle of at least 0.2 microns in diameter and approximately the size desired for the final composite powder is impregnated with a composition comprised of at least one polymer or wax, at least one additional chemical chosen from charge control agents, dyes, pigments, carbon black, or organic chemicals, and optionally additional chemicals chosen from charge control agents, dyes, pigments, carbon black, organic chemicals, or inorganic chemicals.

2. A process according to claim 1 where the inorganic core particle is chosen from porous, amorphous silica, alumina, or titania.

3. A process according to claim 1 where an aqueous or solvent solution or dispersion is formed from a composition that includes at least one polymer or wax and at least one additional chemical chosen from dyes, organic pigments or organic chemicals; the composition is sprayed on the specific particle size inorganic cores; and optionally, the composite particles dried.

4. A process according to claim 1 where an aqueous or solvent solution or dispersion is formed from at least one polymer or wax and at least one additional chemical chosen from dyes, organic pigments or organic chemicals; the composition is added to a quantity of specific particle size inorganic cores approximately sufficient to adsorb all of the liquid; and optionally, the composite particles dried.

5. A process according to claim 1 where a composition consisting of at least one polymer or wax and at least one additional chemical chosen from dyes, organic pigments or organic chemicals are dispersed in a liquid that does not dissolve some or all of the wax or polymer at room temperature; the dispersion is heated to an elevated temperature that does dissolve some or all of the wax or polymer; the dispersion is added to a quantity of the specific particle size inorganic core particles approximately sufficient to absorb all the liquid; the mixture is cooled to precipitate the wax and/or polymer; and optionally, the solvent is evaporated.

6. A process according to claim 1 where a shell or coating is formed on the impregnated core during a secondary step that involves mixing the impregnated cores with a second composition comprised of an aqueous or solvent solution or dispersion consisting of one or more polymers or waxes and optionally dyes, pigments, wax or organic chemicals; and evaporation of the solvent.

7. A process according to claim 1 where a shell or coating is formed on the impregnated core during a secondary step that involves mixing the impregnated cores with a second composition comprised of an aqueous or solvent solution or dispersion of one or more polymers or waxes and optionally dyes, pigments, wax or organic chemicals; addition of a miscible solvent to precipitate the polymer or wax; and optionally, removal of any solvent by drying techniques.

8. A process according to claim 1 where a polymer shell or coating is formed on the impregnated core by a secondary step that involves mixing the impregnated cores with a second composition comprised of monomers and optionally initiators, dyes, pigments, wax, inorganic chemicals or organic chemicals; polymerizing the coating by known polymerization techniques; and optionally, evaporation of any solvent present.

9. A process according to claim 1 where a polymer shell or coating is formed on the impregnated core by a secondary step that involves blending the impregnated core with a composition comprised of one or more fine particles selected from polymers, dyes, pigments, inorganic chemicals or organic chemicals, and optionally heating the coated particles to adhere the coating.

10. A process according to claim 1 where the final composite powder is an electrostatic charge control agent suitable for toners or powder coatings.

11. A composite charge control agent produced according to claim 10 whereby a porous inorganic core particle of at least 0.2 microns in average particle diameter and approximately the size desired for a final composite charge control powder is impregnated with a composition comprised of at least one polymer or wax, at least one suitable charge control chemical and optionally, one or more additional chemicals chosen from commercially available dyes, pigments, carbon black, or organic chemicals.

12. A composite charge control agent produced according to claim 11 where one or more charge control chemicals are adsorbed and not chemically bonded to the inorganic core.

13. A composite charge control agent produced according to claim 11 consisting of 25 to 85% of a porous inorganic core chosen from metal oxides whose particle size is approximately that of the desired final composite charge control agent, from 10 to 75% of one or more organic chemical charge control chemicals, from 5 to 50% wax or polymer and from 0 to 50% of additional modifying compounds.

14. A composite charge control agent produced according to claim 11 where the charge control agent is selected from commercially available or known charge control agents, dyes, organic pigments or organic chemicals.

15. A composite charge control agent produced according to claim 11 where the charge control chemical has been reduced to less than 2 microns and preferably less than 1 micron in particle size

16. A process according to claim 1 where the final composite powder is a dry or liquid toner suitable for electrophotographic, electrostatic, ionographic or magnetographic imaging.

17. A composite dry or liquid toner produced according to claim 16 whereby a porous inorganic core particle of at least 0.2 microns in average particle diameter and approximately the size desired for a final composite toner is impregnated with a composition comprised of at least one polymer or wax, and one or more additional components selected from dyes, organic pigments, organic chemicals, inorganic chemical, or biological chemicals.

18. A composite toner produced according to claim 16 whereby the inorganic core particles are first classified to a size range desired of a final toner.

19. A composite toner produced according to claim 16 whereby an additional shell is formed on the impregnated particles.
